(19) United States
(12) Patent Application Publication
(10) Pub. No.: US 2010/0064847 A1
(43) Pub. Date: Mar. 18, 2010

(54) Fabricated crankshaft using roller bearings

(76) Inventor: Tom Henderson, Scottsburg, OR (US)

Correspondence Address: THE INVENTORS NETWORK, INC., 332 ACADEMY STREET, CARNEGIE, PA, 15106, US

(21) Appl. No.: 12/283,634

(22) Filed: Sep. 15, 2008

(51) Int. Cl. F16C 3/06

(52) U.S. Cl. 74/595

(57) ABSTRACT

A fabricated crankshaft for single and multi-throw crankshafts utilizes roller bearings for achieving energy savings and reducing the size of parts and components with the single throw crankshaft using two throws interconnected by one main bearing pin and one drive end unit connected to each throw and the multi-throw crankshaft including at least two pair of throws, one crank pin interconnecting each pair of throws, a main bearing pin interconnecting both pairs of throws, and a pair of drive end units, with the drive end units and the crank pins, the connecting pins, and main bearing pins being secured to the throws by configurations that include keys and keyways, splines, and left and right hand thread arrangements so that the fabricated crankshaft is adaptable to any number of cylinders required.

### FIELD OF THE INVENTION

The present invention pertains to crankshafts for pumps, compressors, and internal combustion engines, and more particularly pertains to a fabricated crankshaft that utilizes roller bearings.

### BACKGROUND OF THE INVENTION

Crankshaft designs for pumps, compressors, and engines (internal combustion engines) are usually of a one-piece design. A single cylinder model crankshaft generally requires five major components that normally require such machine operations as forging and crankshaft grinding. Crankshafts are further delineated by the number of throws or counterweights they include, and crankshafts can include a single throw, a double throw, or even three throws or counterweights. Crankshafts having two or more throws are referred to as multi throw crankshafts. In addition, typical crankshafts include sleeve bearings on many of their bearing surfaces.

The following patents disclose various types and kinds of crankshaft design: the Dusevoir patent (U.S. Pat. No. 2,013,039), the Bailey patent (U.S. Pat. No. 1,420,905), the Taylor patent (U.S. Pat. No. 2,364,109), and the Burgess patent (U.S. Pat. No. 2,095,968).

Nonetheless, despite the ingenuity of the above devices, there remains a need for a crankshaft design that utilizes roller bearings instead of sleeve bearings.

### SUMMARY OF THE INVENTION

The present invention comprehends a fabricated crankshaft for both single cylinder crankshafts and multi throw crankshafts. The fabricated crankshaft of the present invention allows the designer to utilize roller bearings where previously sleeve bearings had to be used; and by using such roller bearings the present fabricated crankshaft design up to 5 to 10 percent of the energy needed to drive the piece of equipment will be saved by the reduction of drag on the roller bearings. The fabricated crankshaft of the present invention utilizes both a splined arrangement and a keyway arrangement for fastening and holding the components of the crankshaft together.

With regard to a single cylinder crankshaft, a drive end unit will include a key and a bearing area or surface and a spline with a snap ring groove formed back from the drive end unit. The offset leg or throw will include an internal spline on one end and a hole with a key way on the opposite end of the offset leg or throw. Areas or portions of the throws will be recessed so that when the snap ring is in place so that the opposite ends of the hole or aperture extending through the throws will be flush with the opposed sides of the throws. A connecting rod pin will be double ended with opposed keyways and a central bearing area in the middle of the connecting rod pin and snap rings will be placed on both ends of the connecting rod pin. For a single cylinder crankshaft the designer, fabricator, or manufacturer would use two drive end units, two offset legs or throws, and one connecting rod pin for attaching the throws to each other.

It is an objective of the present invention to provide a fabricated crankshaft wherein the installation of the roller bearings occurs before the crankshaft is fully assembled.

It is another objective of the present invention to provide a fabricated crankshaft in which various metals are used to provide for a stronger crankshaft.

It is still yet another objective of the present invention to provide a fabricated crankshaft in which various parts of the crankshaft can be heat-treated to become the race for the roller bearings.

It is still yet a further objective of the present invention to provide a fabricated crankshaft wherein utilization of the roller bearings results in an energy savings of at least 10 percent.

Still another objective of the present invention is to provide a fabricated crankshaft that can be manufactured on a CNC machine with no grinding involved.

Still yet another objective of the present invention is to provide a fabricated crankshaft wherein the use of roller bearings lessens the power drain and saves engine and vehicle energy.

Still yet a further objective of the present invention is to provide a fabricated crankshaft wherein thrust bearings can be incorporated into the cover plates and tapered Timken bearings can be used for the end bearings of the crankshaft.

These and other objects, features, and advantages will become apparent to those skilled in the art upon a perusal of the following detailed description read in conjunction with the accompanying drawing figures and appended claims.

### BRIEF DESCRIPTION OF THE DRAWINGS

FIG. 1 is a perspective view of the fabricated crankshaft of the present invention illustrating the crankshaft in its single throw embodiment;

FIG. 2 is a perspective view of the fabricated crankshaft of the present invention illustrating the crankshaft in its multi-throw embodiment;

FIG. 3 is a side elevational view of the fabricated crankshaft of the present invention illustrating the crankshaft in the multi-throw embodiment;

FIG. 4 is a side elevational view of the fabricated crankshaft of the present invention illustrating the drive end unit for the crankshaft of the single throw embodiment;

FIG. 4a is a side elevational view of the fabricated crankshaft of the present invention illustrating an alternative embodiment for the drive end unit for the crankshaft;

FIG. 5 is a side elevational view of the fabricated crankshaft of present invention illustrating a straight bore crank pin;

FIG. 6 is a side elevational view of the fabricated crankshaft of the present invention illustrating a middle crank pin tapered on both sides;

FIG. 7 is a front elevational view of the fabricated crankshaft of the present invention illustrating one throw for the tapered middle crank pin;

FIG. 8 is a sectioned elevational view of the fabricated crankshaft of the present invention illustrating the throw shown in FIG. 7 taken along sectional lines 8-8 of FIG. 7;

FIG. 9 is a side elevational view of fabricated crankshaft of the present invention illustrating a straight bore multi-throw crankshaft;

FIG. 10 is side elevational view of the fabricated crankshaft of the present invention illustrating one drive end unit for the straight bore multi-throw crankshaft first shown in FIG. 9;

FIG. 11 is a side elevational view of the fabricated crankshaft of the present invention illustrating one crank pin for the straight bore multi-throw crankshaft first shown in FIG. 9;

FIG. 12 is a side elevational view of the fabricated crankshaft of the present invention illustrating one middle bearing pin for the straight bore multi-throw crankshaft first shown in FIG. 9;

FIG. 13 is a front elevational view of the fabricated crankshaft of the present invention illustrating one throw for the various pins shown in FIGS. 9-12;

FIG. 14 is a side elevational view of the fabricated crankshaft of the present invention illustrating the throw shown in FIG. 13 that interconnects the various pins shown in FIGS. 9-12;

FIG. 15 is a front elevational view of the fabricated crankshaft of the present invention illustrating an alternative embodiment for one of the openings of the throw first shown in FIG. 1;

FIG. 16 is a side elevational view of the fabricated crankshaft of the present invention illustrating the openings for the crankshaft throw first shown in FIG. 15;

FIG. 17 is a side elevational view of the fabricated crankshaft of the present invention illustrating one drive end unit for the throws first shown in FIG. 15 and FIG. 16;

FIG. 18 is a side elevational view of the fabricated crankshaft of the present illustrating one middle bearing pin for the throw of the crankshaft first shown in FIGS. 15 and 16;

FIG. 19 is a front elevational view of the fabricated crankshaft of the present invention illustrating an alternative embodiment for the throw that includes two splined openings;

FIG. 20 is a side elevational view of the fabricated crankshaft of the present invention illustrating the alternative embodiment for the throw first shown in FIG. 19;

FIG. 21 is a side elevational view of the fabricated crankshaft of the present invention illustrating one middle crank pin for use with the throws first shown in FIGS. 19 and 20;

FIG. 22 is a side elevational view of the fabricated crankshaft of the present invention illustrating an alternative embodiment for a crankpin that includes oppositely disposed tapered bores;

FIG. 23 is a front elevational view of the fabricated crankshaft of the present invention illustrating an alternative embodiment for the crankshaft first shown in FIG. 1 that includes openings to accommodate the tapered bore crankpin of FIG. 22;

FIG. 24 is a side elevational view of the fabricated crankshaft of the present invention illustrating the use of a fastener and a spring expander in conjunction with the crankpin and throw first shown in FIGS. 22 and 23;

FIG. 25 is a side elevational view of the fabricated crankshaft of the present invention illustrating an alternative embodiment for the crankpin wherein the crankpin includes a straight bore;

FIG. 26 is a front elevational view of the fabricated crankshaft of the present invention illustrating the openings of the throw that accommodate the straight bore crank pin first shown in FIG. 25;

FIG. 27 is a side elevational view of the fabricated crankshaft of the present invention illustrating the alignment of a fastener with one of the openings of the throw of the crankshaft first shown in FIG. 26;

FIG. 28 is a side elevational view of the fabricated crankshaft of the present invention illustrating an alternative embodiment for a crank pin that includes left and right hand threads; and

FIG. 29 is a side elevational view of the fabricated crankshaft of the present invention illustrating the throw first shown in FIG. 28 having a shorter crank pin being brought in alignment with threaded apertures of the throw.

### DETAILED DESCRIPTION OF THE PREFERRED EMBODIMENT

Illustrated in FIGS. 1-29 is a design for a fabricated crankshaft that utilizes roller bearings instead of sleeve bearings for both single cylinder crankshafts and multi-throw or multi-cylinder crankshafts with the interconnections of the various drive end units, crank pins, and main bearing pins to the throws being through keyed, splined, or left and right hand threaded configurations. The keyed or the splined configurations can be used depending on horsepower requirements, and roller bearings are used to lessen the power drain and save energy.

The primary components of the single cylinder arrangement are a pair of throws (also referred to as offset legs or counterweights), a pair of drive end units with one drive end unit connected to each throw, and a main bearing pin. A multi-throw or multi-cylinder arrangement would include two pairs of throws with each pair of throws having opposed flat surfaces and being interconnected by a crank pin in various keyed, splined, or threaded configurations, one main bearing pin interconnecting both pair of throws, and a pair of drive end units with one drive end unit connected to each outside throw of each pair of throws.

Thus, FIG. 1 illustrates a single cylinder crankshaft 10 that includes a pair of throws or counterweights 12 interconnected by a main bearing pin 14. The throws 12 are mirror images of each other and each has a drive end unit 16 attached thereto. Each drive end unit 16 includes a key 18, a stub 20 and a cylindrical bearing portion 22. Throws 12 include two apertures with one aperture for receiving the drive end units 16 and the other aperture for receiving the main bearing pin 14. One aperture on each throw 12 includes a keyway 24 for receiving a key of main bearing pin 14 and a self locking nut 26 further secures main bearing pin 14 to the throws 12 with one self locking nut 26 used on either end of main bearing pin 14.

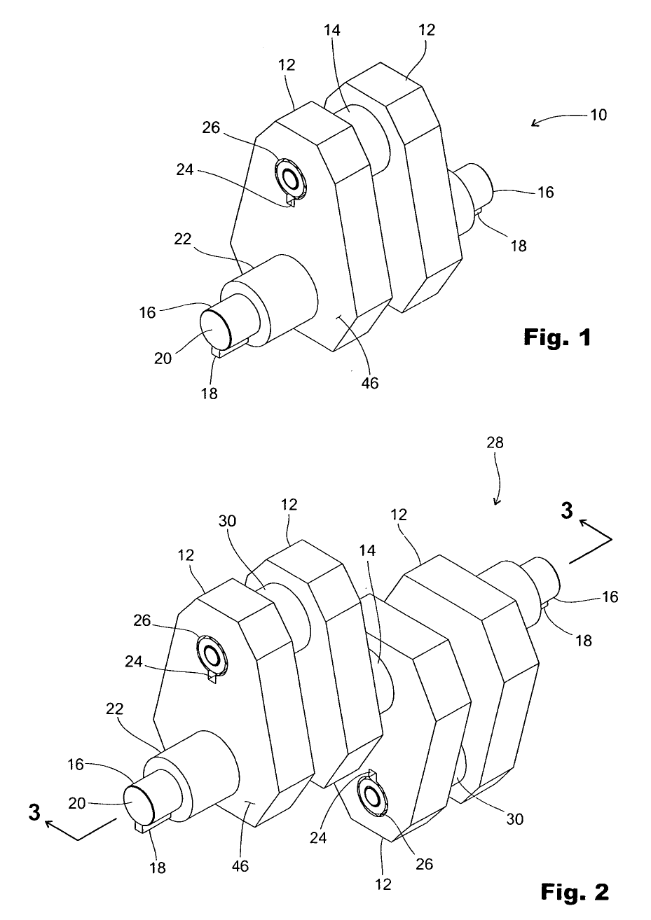

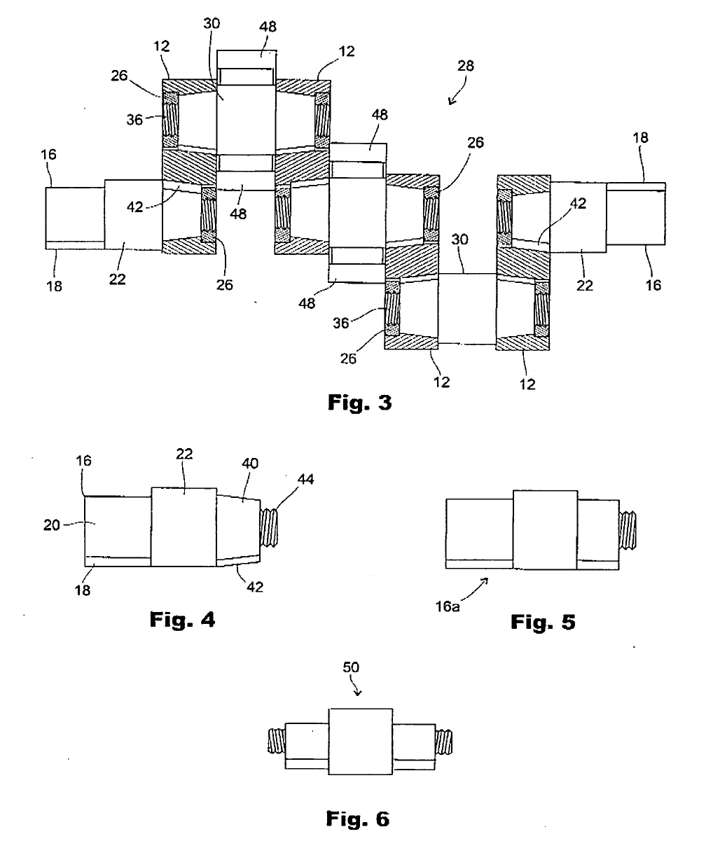

FIGS. 2-4 illustrate a multi-throw crankshaft 28 that includes the same components as shown in FIG. 1 but in a different number and configuration. Multi-throw crankshaft 28 includes two pairs of throws 12 with each pair interconnected by a crank pin 30. Crank pins 30 include tapered portions 32, keys 34 and opposed axially aligned and threaded ends 36 for aligning and locking crank pins 30 within apertures 38 of throws 12. Drive end units 16 also include an inner tapered portion 40 having a key 42 projecting laterally therefrom with inner tapered portion 40 terminating with an inner threaded end 44. Tapered portions 32 for crank pins 30 and inner tapered portions 40 for drive end units 16 are threadably received within apertures 38 of throws 12 and maintained in position by self locking nuts 26 that are flush with opposed flat surfaces 46 of throws 12. Main bearing pin 14 of FIGS. 2 and 3 has no counterweight. In addition, roller bearings 48 are disposed about one crank pin 30 and middle bearing pin 14 of the multi-throw crankshaft 28 shown in FIG. 3.

FIG. 5 illustrates an alternative embodiment for crank pins 30 of FIGS. 1-4. The crank pin 50 of FIG. 5 is for straight bore throws or crankshafts and is used where space is an issue in various types of pumps, compressors, and engines. FIG. 6 illustrates a middle crank pin 52 that includes a cylindrical main bearing portion 54, tapered and opposed cylindrical members 56, a key 58 for each cylindrical member 56, and opposed threaded studs 60 projecting from each cylindrical member 56 and which are in axial alignment with each other.

FIGS. 7 and 8 illustrate throws 12 for use with tapered drive end units 16, crank pins 30 and 50 and main bearing pins 14 and 52 shown in FIGS. 2, 3, 4 and 6. Throws 12 of FIGS. 7 and 8 include pairs of tapered openings 62 with the taper of each opening 62 for each pair of openings 62 of each throw 12 being opposite or the mirror image of each other, and each opening 62 also including an annular seating portion 64 and a keyway 66.

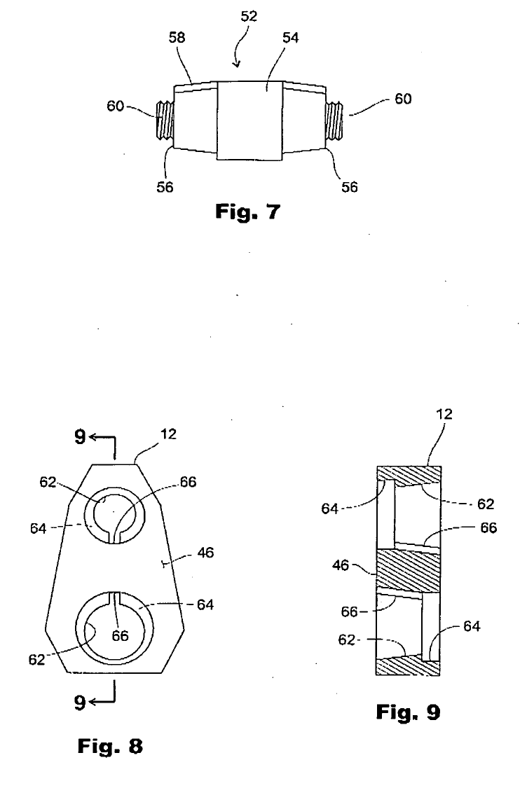

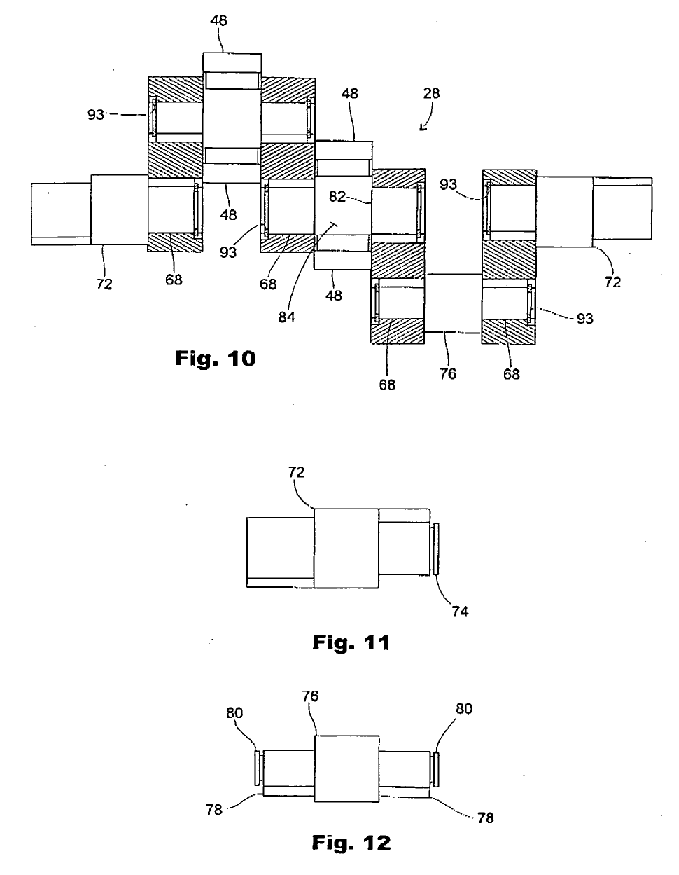

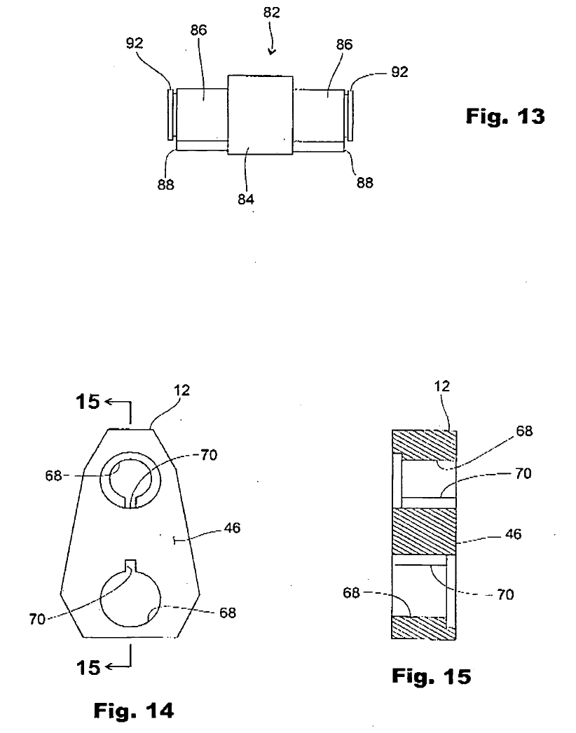

FIGS. 9-14 illustrate the multi-throw crankshaft 28 that includes an alternative embodiment of straight bore openings instead of tapered openings 62. Thus, each throw 12 includes a pair of straight bore openings 68 and each opening 68 includes a keyway 70. FIG. 10 illustrates a straight bore drive end unit 72 having a flanged inner end portion 74 and FIG. 11 illustrates a straight bore connecting rod pin 76 for connecting each pair of throws 12 shown in FIG. 9. Connecting rod pin 76 includes opposed keys 78 and terminates at each end with an annular flanged portion 80. FIG. 12 illustrates a middle bearing pin 82 having a central annular bearing surface 84, opposed cylindrical portions 86 each of which includes a key 88, and opposed cylindrical portions 90 terminating with annular flanged portions 92. FIGS. 13 and 14 illustrate the configuration of the pairs of openings 68 for each throw 12 that accommodates and receives pins 72, 76, and 82. Specifically, the straight bore lower opening 68 for each throw 12 receives drive end units 72 and upper openings 68 are configured to receive connecting rod pins 76 and middle bearing pin 82. Snap rings 93 instead of self-locking nuts 26 are placed upon flanged inner end portions 74 of drive end units 72, annular flanged portions 80 of connecting rod pins 76, and annular flanged portions 92 of middle bearing pin 82 to further secure drive end units 72, connecting rod pins 76 and middle bearing pin 82 in openings 68 of throws 12. In addition, roller bearings 48 are shown as being disposed circumjacent one connecting rod pin 76 and middle bearing pin 82 in FIG. 9.

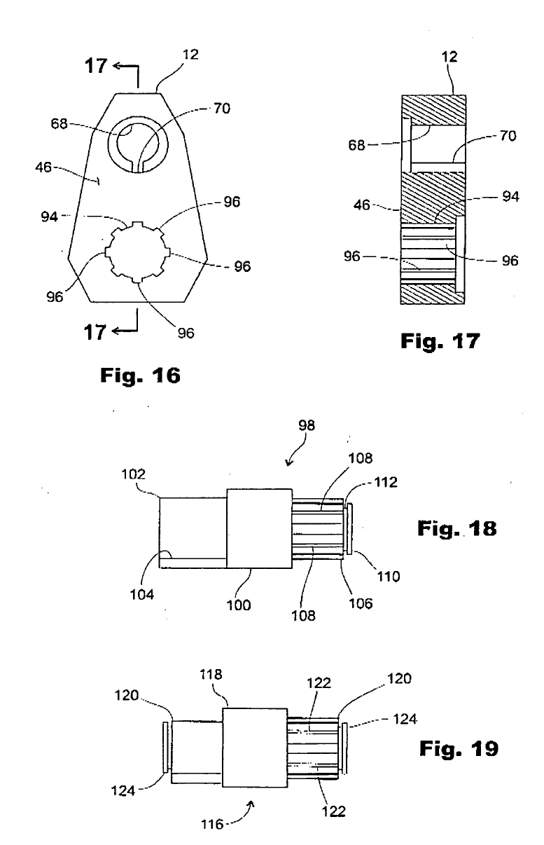

FIGS. 15-21 illustrate an embodiment for both single cylinder and multi-cylinder crankshafts 10 and 28 that accommodates splined components and parts. Thus, the throws 12 shown in FIGS. 15 and 16 include one straight bore opening 68 and one splined opening 94 with the splined opening 94 including a plurality of individual splines 96 circumjacently spaced about the opening 94 which for the throw 12 of FIGS. 15 and 16 is the lower opening 94. FIG. 17 illustrates a drive end unit 98 having a middle portion 100, a cylindrical portion 102 having a key 104 projecting therefrom, and an opposite cylindrical splined portion 106 having a series of splines 108 projecting therefrom. A flanged portion 110 extends from the cylindrical splined portion 106 and includes an inner annular recess 112 for receiving a snap ring such as snap ring 93. FIG. 18 illustrates a middle bearing pin 116 that includes a cylindrical central bearing portion 118, opposed end portions 120 one of which includes a series of splines 122, and flanged terminating portions 124 onto which the snap ring 93 can be placed for locking the pin 116 to the throws 12.

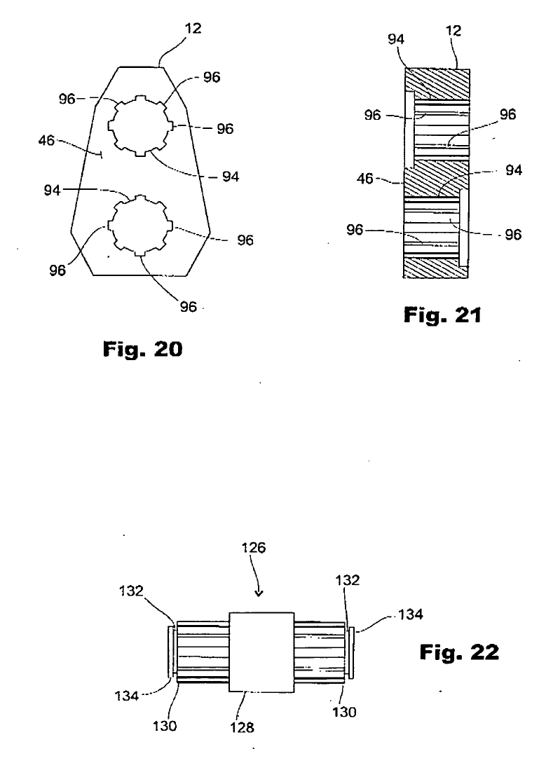

FIGS. 19 and 20 are a front elevational view of the throw 12 modified for accommodating and receiving the aforedescribed components and parts. The throw 12 has both the upper and lower openings 94 with each opening 94 including the plurality of splines 96 defining and circumjacent each respective opening 94. FIG. 21 illustrates a connecting rod pin 126 that is a smaller version of the middle bearing pin 116 shown in FIG. 18. The connecting rod pin 126 includes a central bearing portion 128, opposed splined ends 130, necks 132 projecting axially from each opposed splined end 130, and a flange 134 extending from each neck 132 for receiving the snap ring 93 in a groove formed between the neck 132 and flange 134.

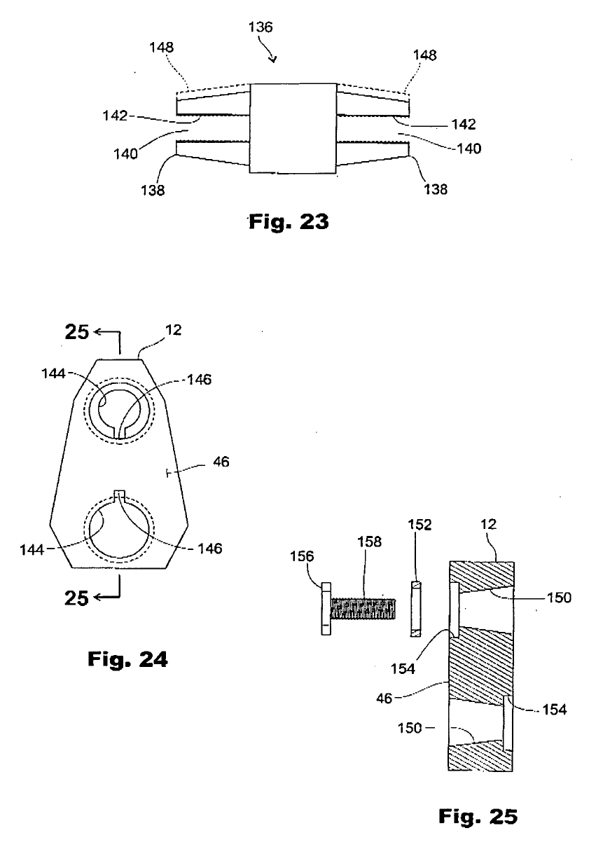

FIGS. 22-29 disclose embodiments for throw 12 and various connecting and bearing pins that include threaded engagements with, specifically, right and left hand threaded components, configurations and connections. FIG. 22 illustrates a crank pin 136 having a taper bore that includes opposed tapered ends 138 with each tapered end 138 defining a bore 140 and each bore 140 having annular inner threads 142. FIG. 23 illustrates an embodiment for the throw 12 of FIGS. 1-3 that includes openings 144 (upper and lower) with each opening 144 having a keyway 146 for receiving the key 148 on crank pin 136 of FIG. 22. FIG. 24 is a side elevational view of the throw 12 modified to include a pair of tapered apertures 150 sized to receive the crank pin 136 with the taper bore of FIG. 22. To further secure the crank pin 136 to the throw 12 an expander 152 is disposed in an annular recess 154 formed on each opening 144 and then a fastener 156 such as a stud or bolt having a threaded stem 158 is threadably secured to the inner annular threads 142 of the crank pin 136 that has been seated in the tapered apertures 150 of the throw 12.

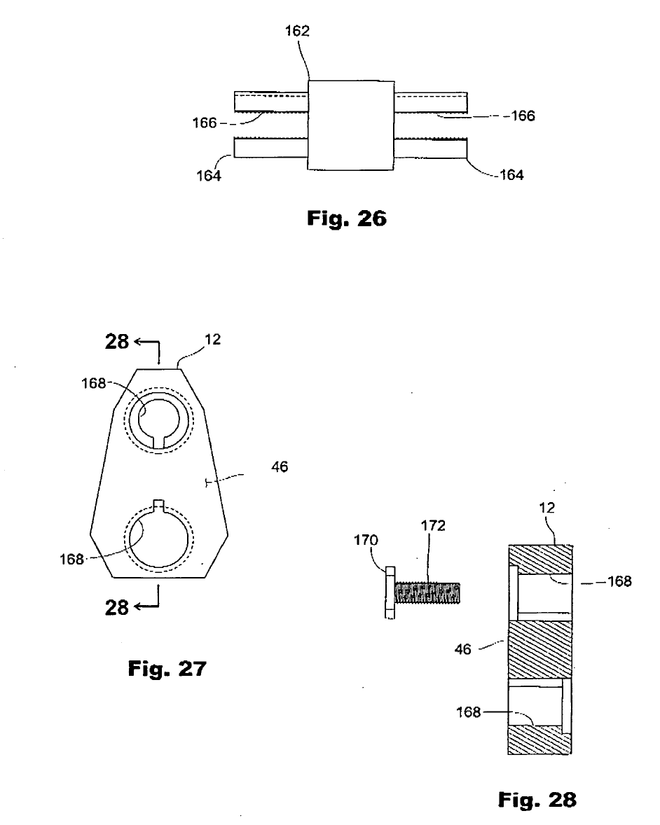

FIGS. 25-27 illustrate an alternative embodiment to the configuration of the apertures 38 of throws 12 and the pins 14, 30 and 50 shown in FIGS. 1-5 which utilizes a straight bore crank pin 160. Thus, straight bore crank pin 160 includes a cylindrical central portion 162 that can function as a bearing surface and opposed straight bore portions 164 each of which includes internal annular threads 166 that can be either left-handed or right-handed. Crank pin 160 is inserted into either opening 168 of throw 12 shown in FIGS. 26 and 27, and then further fixed in place by having a fastener 170 with an externally threaded shank 172 threadably engage internal annular threads 166 of straight bore crank pin 160 for assembling components of the crankshaft whether single 10 or multi-throw 28.

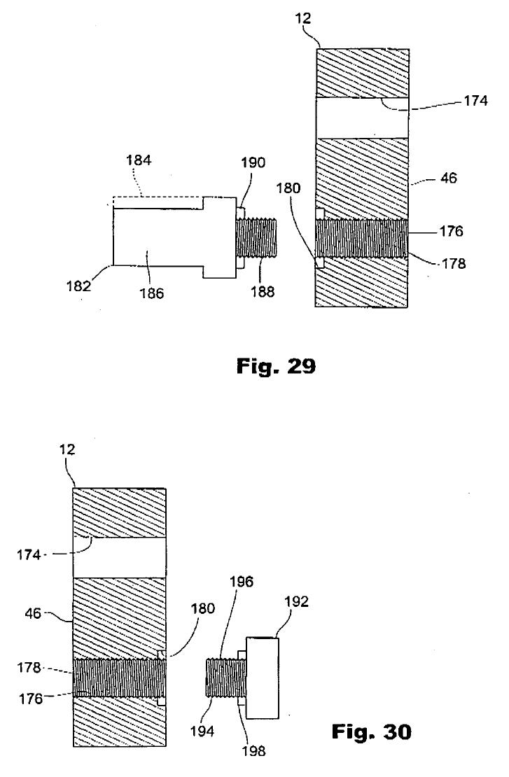

FIGS. 28 and 29 illustrate embodiments for a throw configuration and crank pin having either left-handed or right-handed threads. Thus, the throws 12 of FIGS. 28 and 29 have their openings modified so that one opening 174 is configured as a cylinder and the other opening 176 includes annular internal threads 178. An annular groove 180 is formed at the point where the opening 176 registers flush with one surface of the throw 12. FIG. 28 illustrates a long stem crank pin 182 having a key 184, a central enlarged flanged portion 186 and a short threaded stub 188 with an annular ledge 190 formed at the base of the short threaded stub 188 adjacent the central enlarged flanged portion 186. The threaded stub 188 can be either right-handed or left-hand threaded, as circumstances may warrant, and will correspondingly mate with the annular internal threads 178—either right-handed or left-handed in correspondence therewith—for threadable engagement thereto. FIG. 29 illustrates a shortened crank pin 192 having only a cylindrical body portion 194 and a threaded portion 196 with an annular ledge 198 formed at the area where the threaded portion 196 connects to the cylindrical body portion 194. The threads of the crank pin 192 can be either right-handed or left-handed to correspondingly engage and mate with the annular internal threads 178—that are also correspondingly right-handed or left-handed as the circumstance and situation warrants.

While the roller bearings 48 are shown being used with the throws 12 of FIGS. 3 and 9 for representative purposes, it should be understood that the roller bearings 48 can be used with all the various throw 12 and pin configurations—single and multi, straight and tapered—shown in FIGS. 1 and 2 and 10-29.

Although the various aspects of the invention have been described with respect to specific exemplary embodiments, it will be understood that numerous modifications, alterations, and variations are practicable and possible to those skilled in the art, and that such modifications, alterations, and variations will come within the ambit of the appended claims and thus the invention, and all its contemplated variations and embodiments, are entitled to the full, complete, and extensive protection of the broad scope of the appended claims.

I claim:

1. A single throw crankshaft for a motor utilizing roller bearings, comprising:
a pair of throws with each throw having a pair of tapered openings with each tapered opening including an annular seating portion and a keyway;
a pair of drive end units with each drive end unit for insertion into and securement to one tapered opening of one throw and each drive end unit having a cylindrical bearing portion, an inner tapered portion, a key projecting laterally from the inner tapered portion and a threaded end projecting from the inner tapered portion;
a main bearing pin having a cylindrical main bearing portion and tapered and opposed cylindrical members with each tapered and each opposed cylindrical member having a key for fitting into the keyways of the throws; and
whereupon the roller bearings bear upon the cylindrical main bearing portion of the main bearing pin to facilitate the rotational movement of the crankshaft during operation of the motor.

2. The single throw crankshaft of claim 1 further comprising a plurality of self-locking nuts with the self locking nuts for locking the drive end units and the main bearing pins to the throws.

3. A multi-throw crankshaft for a mechanical device utilizing roller bearings, comprising:
at least two pairs of throws with each throw for each pair including a straight bore opening and a keyway extending through the straight bore opening;
at least a pair of drive end units with each drive end unit having a flanged inner end portion with the flanged inner end portions being received within at least one straight bore opening of one throw of each pair of throws;
at least a pair of connecting rod pins with each connecting rod pin interconnecting the throws of each pair of throws;
each connecting rod pin including opposed keys that are received in the keyways of the throws and opposed ends that terminate with an annular flanged portion;
a middle bearing pin having a central annular bearing surface, opposed cylindrical portions with each opposed cylindrical portion including a key and each opposed cylindrical portion terminating with an annular flanged portion; and
whereupon the middle bearing pin interconnects the pairs of throws to each other and each connecting rod pin interconnects the throw for each pair of throws to each other and the roller bearings bear against the central annular bearing of the middle bearing pin and the connecting rod pins to facilitate the angular motion of the crankshaft during operation of the mechanical device.

4. The multi-throw crankshaft of claim 3 further comprising a plurality of snap rings with the snap rings fitted onto the flanged inner end portions of the drive end units, the annular flanged portions of the connecting rod pins and the annular flanged portions of the middle bearing pin for locking drive end units, the connecting rod pins, and the middle bearing pin to the throws.

5. A multi-throw crankshaft for a mechanical device utilizing roller bearing, comprising:
at least two pair of throws with each throw including at least one straight bore opening and one splined opening with the splined opening including a plurality of splines;
at least a pair of drive end units with each drive end unit including a middle portion, a cylindrical portion, a key projecting from the cylindrical portion, a cylindrical splined portion located opposite of the cylindrical portion and a flanged portion extending from the cylindrical portion;
a middle bearing pin including a cylindrical central bearing portion, opposed end portions at least one of which includes circumjacent splines and a flanged terminating portion extending from the end portion that includes the circumjacent splines;
a plurality of connecting rod pins with each connecting rod pin including a central bearing portion, opposed splined ends, a neck extending from each splined end and each neck terminating with a flange; and
whereupon the middle bearing pin drivingly interconnects both pairs of throws and wherein the cylindrical splined portion of each drive end unit is inserted into the splined opening of one throw of each pair of throws and the connecting rod pins interconnect the throws for each pair of throws with the roller bearings bearing against the central bearing portions of the connecting rod pins and the cylindrical central bearing portion of the middle bearing pin to facilitate the angular motion of the crankshaft during the operation of the mechanical device.

6. The multi-throw crankshaft of claim 5 wherein the throws can include two splined openings.

7. The multi-throw crankshaft of claim 6 further comprising a plurality of crank pins with each crank pin having opposed tapered ends and each tapered end defining a bore having annular inner threads.

8. The multi-throw crankshaft of claim 7 wherein the annular inner threads of the bores are right-handed.

9. The multi-throw crankshaft of claim 8 wherein the annular inner threads of the bores are left-handed.

10. The multi-throw crankshaft of claim 9 further comprising a plurality of crank pins with each crank pin having opposed straight bore portions and each straight bore portion including internal annular threads.

11. The multi-throw crankshaft of claim 10 wherein the internal annular threads are left-handed.

12. The multi-throw crankshaft of claim 11 wherein the internal annular threads are right-handed.
